(19) United States
(12) Patent Application Publication
(10) Pub. No.: US 2019/0170468 A1
(43) Pub. Date: Jun. 6, 2019

(54) RIFLE CLEANING DEVICE AND METHOD OF USING

(71) Applicant: Dakota James Adcock, Hampstead, NC (US)

(72) Inventor: Dakota James Adcock, Hampstead, NC (US)

(21) Appl. No.: 15/831,519

(22) Filed: Dec. 5, 2017

(51) Int. Cl. F41A 29/00; B08B 9/02

(52) U.S. Cl. CPC F41A 29/00; B08B 9/021

(57) ABSTRACT

An elongated weapon cleaning device defines apertures sized and shaped to receive and frictionally secure the stick portion of a cotton swab segment. Integrated hinges facilitate insertion of the stick and exertion of frictional holding forces on the stick. The cotton swab segment protrudes at an angle that permits access to all surfaces of a locking lug within the chamber of the weapon, and in particular the back surface of the locking lug which is particularly difficult to reach. A cotton swab segment can be inserted upwardly or downwardly into the aperture, thereby causing the cotton swab segment to protrude at an angle, or the corresponding supplementary angle, for each aperture.

### BACKGROUND OF THE INVENTION

The present invention relates to weapon maintenance, and more specifically, to a tool configured to hold at least one segment of a cotton swab for cleaning the chamber of rifles, and especially bolt action and semi-automatic rifles.

While both bolt action and semi-automatic rifles are a staple of the military, they are also commonly used in hunting, competitive shooting, and tactical applications. Examples of well-known bolt action and semi-automatic rifles include the Remington 700, AR-15, and the M-16. While the uses of these weapons vary, they share a defining structural characteristic insofar as they all utilize a rotating locking bolt.

With the bolt action rifle, the Remington 700, the weapon's bolt is operated manually by opening and closing the chamber with the rotation of a small handle. A gas operated semi-automatic rifle, the AR-15 and the M-16, also utilizes a rotating bolt; however, when the weapon is fired, internal combustion builds gas pressure to automatically unlock then open and close the chamber.

These complicated, mechanical devices are known to be very consistent, accurate and durable, if kept meticulously clean. Firing residues such as carbon, barium, antimony and lead, as well as environmental contaminants such as grit and oil, must be cleaned from the chamber and associated inner mechanical parts such as the bolt locking lugs. Failure to remove these contaminants will cause the rifle to malfunction and/or become damaged.

Unfortunately on these style rifles, due to the design of the chambers and chamber locking mechanisms, the bolt locking lugs hereafter referred to as locking lugs, are difficult to clean due to limited accessibility. This is primarily because the chamber consists of a recessed port that houses the locking lugs. On bolt action rifles, the chamber and the locking lugs can only be accessed through the ejection and loading port of the receiver. This recessed area has blind surfaces that cannot be seen or easily touched. On gas operated rifles the chamber and locking lugs can be accessed by separating the upper and lower receivers, and then removing the bolt carrier group. Although the rifle can be broken down to provide better access to the chamber, there is still limited access to the back of the locking lugs. The locking lugs are the key component to the operation of these rifles, making it imperative that the entire area is clean of contaminants and debris.

Referring to FIG. 1, the chamber within the upper receiver 71 is accessed by removing bolt carrier group 76 including bolt 77, thereby providing better access to chamber 72 and locking lugs 74.

A variety of rifle cleaning implements are used in an attempt to access the hard-to-reach areas of a rifle, including brushes, rags, pads, cotton swabs, and an extension rod to insert a cleaning implement deeper into the weapon's chamber. While these implements and arms are useful, some surfaces in the chamber still cannot be easily reached. In particular, referring to FIG. 2, many cleaning implements can reach front, top and side locking lug surfaces 74a, 74b, 74c, respectively, but it is difficult to reach the back locking lug surface 74d. This accessibility challenge is akin to trying to brush the lingual (towards the tongue) surface of a front tooth with the mouth barely opened.

Cotton swabs are commonly used to clean rifles, especially in military settings. They are desirable cleaning implements insofar as they are economical, easy to transport, and effective on the areas they can reach. However, cotton swabs cannot reach all the regions of the rifle that require cleaning, and in particular, the back surface of the locking lug. This is depicted in FIG. 3 which shows cotton swab head 62 in contact with front, top and side locking lug surfaces 74a, 74b, 74c, respectively, but not the back side of the locking lug surface 74d.

People frustrated by the limited access of cotton swabs have attempted to access the back locking lug surfaces by bending the “stick” portion of a cotton swab. While this aids in being able to access the desired area, the integrity of the cotton swab is compromised since the wooden or cardboard “stick” is significantly weakened. Thus only light pressure can be applied for cleaning lest the “stick” may break, thereby undesirably depositing a cotton swab segment within the weapon which may be difficult to retrieve. Light pressure is also typically inadequate to properly clean the weapon and remove built up debris.

As can be seen, there is a need for a rifle cleaning device that offers the benefits of a cotton swab, while providing the capability of accessing the harder to reach areas of the weapon. It is desirable that the cleaning device is economical, easy to transport, easy to use, easy to manufacture, and can be used with a variety of sizes and styles of cotton swabs. It is also desirable that the cleaning device is optimally sized and shaped for use with specific weapons.

### SUMMARY OF THE INVENTION

An elongated weapon cleaning device has at least one aperture at a terminal end that is sized and shaped to receive and frictionally secure the stick portion of a cotton swab. The aperture can be temporarily slightly enlarged due to an integrated hinge, thereby allowing insertion of the stick then exertion of frictional holding force on the stick. The cotton swab, or more likely the cotton swab segment, is secured at an angled position in order to access and clean all surfaces of a locking lug within the chamber of the weapon, and in particular the back surface of the locking lug which is particularly difficult to reach. A cotton swab segment can be inserted upwardly or downwardly into the aperture, thereby causing the cotton swab segment to protrude at an angle, or the corresponding supplementary angle, for each aperture.

The invention includes four preferred embodiments: a linear cleaning device embodiment having one aperture at each of both ends (FIGS. 5 and 6); a single bend cleaning device embodiment having one aperture at each of both ends (FIGS. 7 and 8); a double bend cleaning device embodiment having one aperture at each of both ends (FIGS. 9 and 10); and a screw-on cleaning device embodiment having one aperture at one end for use with commercially available weapon cleaning kits (FIGS. 13 and 14).

In use, one breaks down the weapon to expose the inside of the upper receiver, removes the bolt carrier group from the upper receiver, inserts the cotton swab stick portion of a cotton swab segment into the aperture of a cleaning device, and cleans the surfaces of the upper receiver, chamber and locking lugs.

### BRIEF DESCRIPTION OF THE DRAWINGS

FIG. 1 is an upper receiver of a known bolt action semi-automatic rifle;

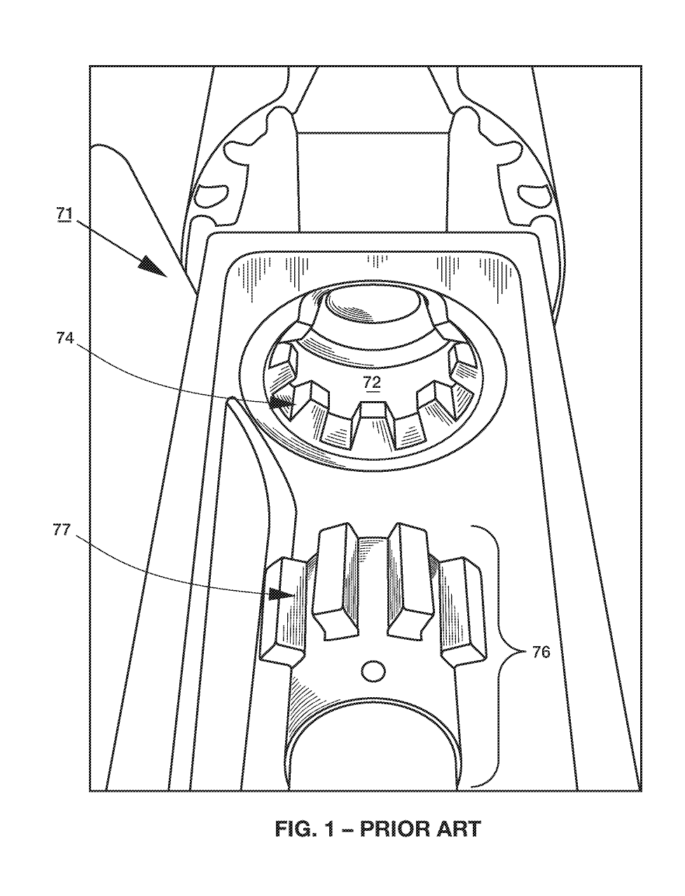

FIG. 2 is a close-up view of the chamber of a known semi-automatic rifle showing the various surfaces of a locking lug;

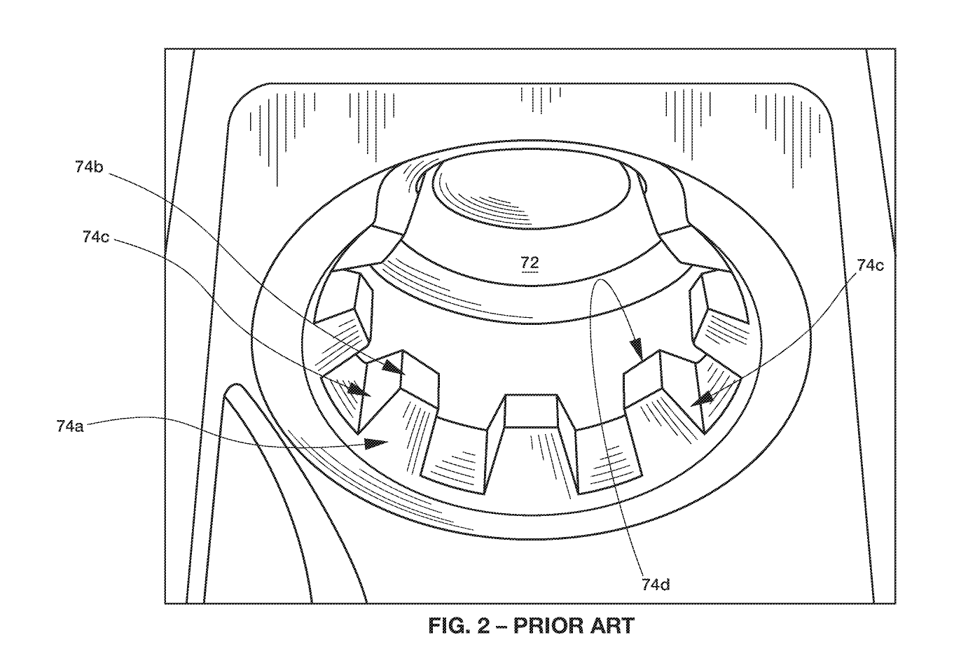

FIG. 3 depicts a conventional cotton swab cleaning locking lug surfaces;

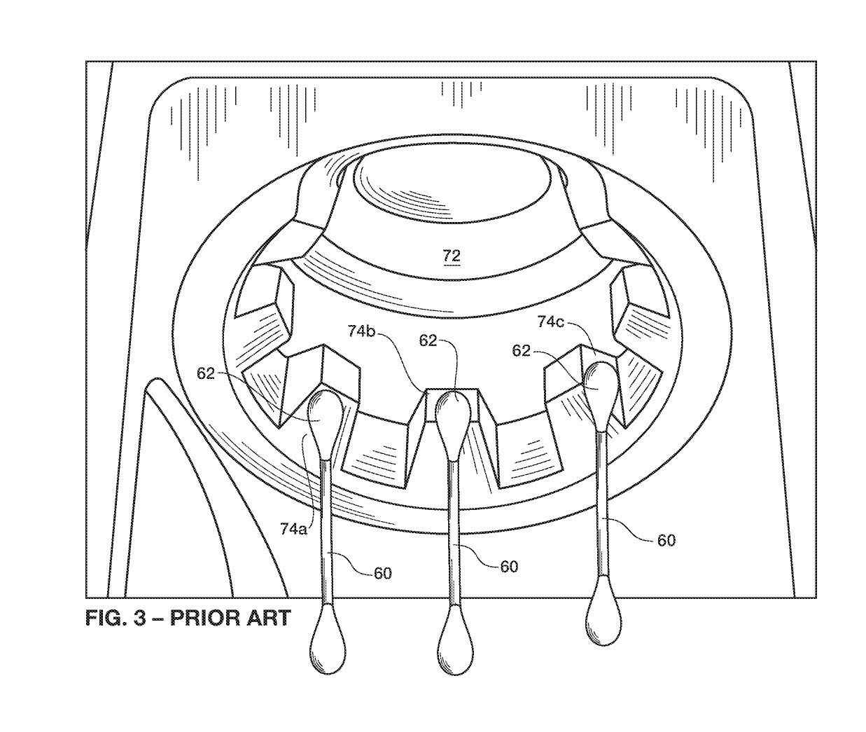

FIG. 4 depicts an embodiment of the present invention cleaning the back surface of a locking lug;

FIG. 5 depicts a top view of a linear cleaning device embodiment;

FIG. 6 depicts a perspective view of a linear cleaning device embodiment with a cotton swab segment inserted in one end;

FIG. 7 depicts a top view of a single bend cleaning device embodiment;

FIG. 8 depicts a perspective view of a single bend cleaning device embodiment with a cotton swab segment inserted in one end;

FIG. 9 depicts a top view of a double bend cleaning device embodiment;

FIG. 10 depicts a perspective view of a double bend cleaning device embodiment with a cotton swab segment inserted in one end;

FIG. 11 depicts an embodiment of the present invention cleaning the front surface of a locking lug on a Remington 700, shown in a partial sectional view;

FIG. 12 depicts two double bend cleaning devices with a cotton swab segment inserted in each end;

FIG. 13 depicts a perspective view of a screw-on cleaning device embodiment; and

FIG. 14 depicts a perspective view of a screw-on cleaning device embodiment connected to a rod with a cotton swab segment inserted in one end.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structure numbers shall apply to the following structures among the various FIGS.:

10—Cleaning device;

12—Linear cleaning device embodiment;

14—Single bend cleaning device embodiment;

16—Double bend cleaning device embodiment;

18—Screw-on cleaning device embodiment;

20—Elongated member;

21—Axis;

22—Bend;

23—Angle;

24—First terminal end;

25—Second terminal end;

26—Aperture;

27—First hinge;

28—Second hinge;

29—Attachment means;

30—Rod;

60—Cotton swab stick;

62—Cotton swab head;

63—Cotton swab segment;

70—Bolt action rifle;

71—Upper receiver;

72—Chamber;

74—Locking lug;
74a—Front locking lug surface;
74b—Top locking lug surface;
74c—Side locking lug surface;
74d—Back locking lug surface;

76—Bolt carrier group;

77—Bolt;

78—Barrel

80—Longer segment; and

81—Shorter segment.

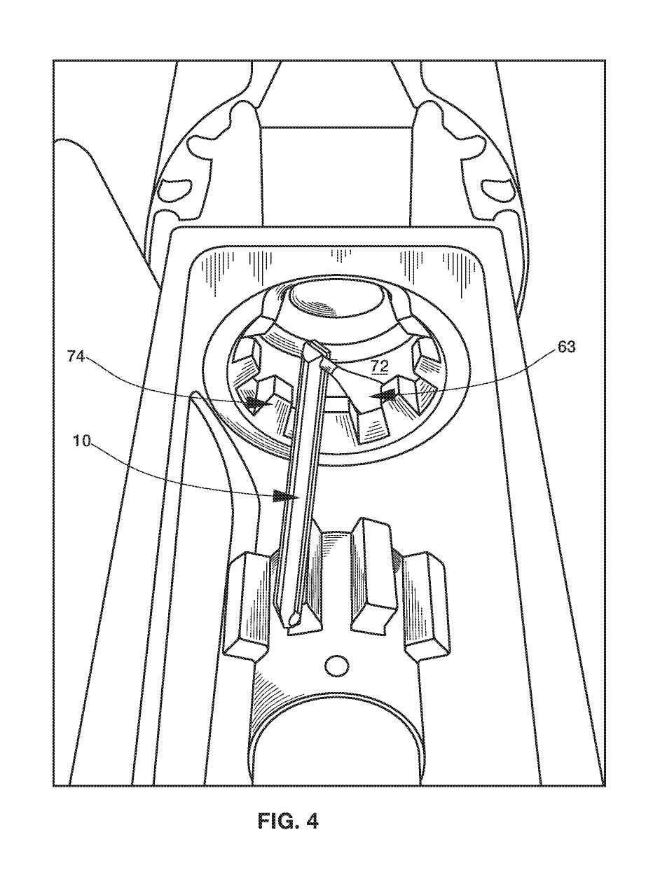

Referring to FIG. 4, cleaning device 10 is configured to secure cotton swab segment 63 in an angled position so cotton swab can access and clean all surfaces of locking lug 74, for example in an AR-15 rifle. As used herein a cotton swab segment includes a single swab head 62 plus a cotton swab stick 60. A cotton swab segment is typically obtained by breaking the ends off of a conventional cotton swab such as a Q-TIP.

There are four preferred embodiments of the present invention: linear cleaning device embodiment 12; single bend cleaning device embodiment 14; double bend cleaning device embodiment 16; and screw-on cleaning device embodiment 18.

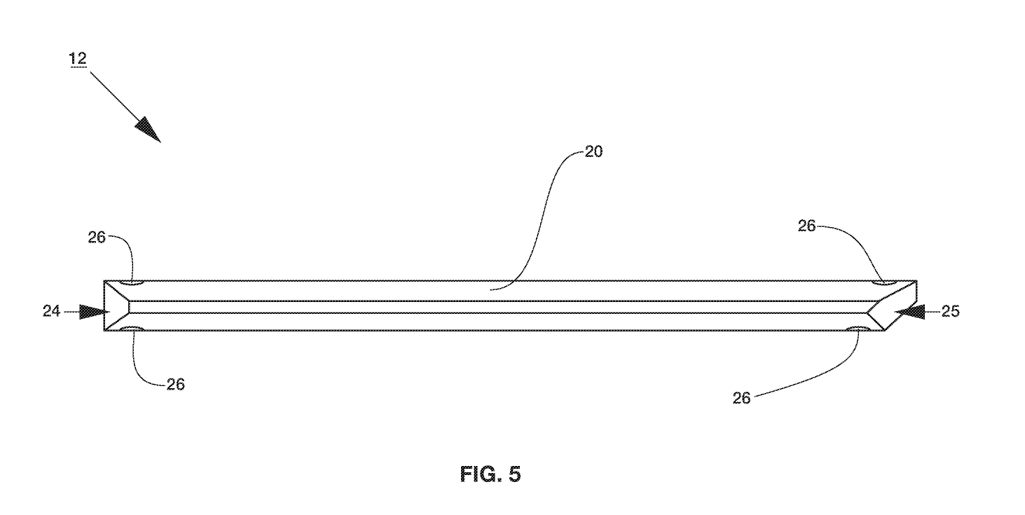

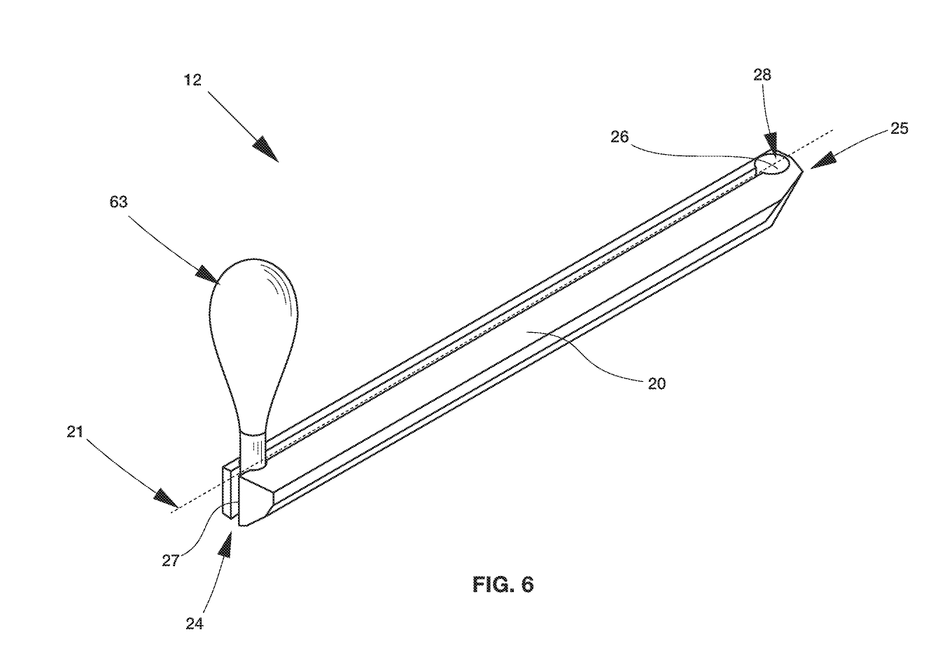

Referring to FIG. 5, linear cleaning device embodiment 12 generally includes elongated member 20 having a first terminal end 24 and a second terminal end 25, with one aperture 26 traversing each terminal end. As shown in FIG. 6, first terminal end 24 defines first hinge 27, which allow temporary expansion of aperture 26 to accept and frictionally retain cotton swab segment 63. Second hinge 28 defined by second terminal end 25 shown in other figures works identically. Hinges are continuous with apertures insofar as expansion of hinge arms enlarges aperture and the channel between hinge arms is continuous with the aperture. Cotton swab segment 63 is retained in a non-linear angle position to axis 21 of cleaning device 10. More specifically, in linear cleaning device embodiment 12, longitudinal axis of first hinge 27 is preferably approximately 90° relative to axis 21, while longitudinal axis of second hinge 28 is preferably approximately 45° relative to axis 21. Thus, cotton swab segment can protrude 90°, 45° or 135° relative to axis 21 depending on which terminal end the cotton swab segment protrudes from, and in the case of second terminal end 25, whether the cotton swab segment is oriented upwardly (135°) or downwardly (45°). In linear cleaning device embodiment 12, the tip-to-tip length is approximately 4″, and it is approximately 0.20″ thick. Apertures are preferably approximately 0.095″ in diameter in order to accommodate cotton swab sticks which are generally 0.097-0.110 inches in diameter. This is particularly suited for M16/AR15 style weapons.

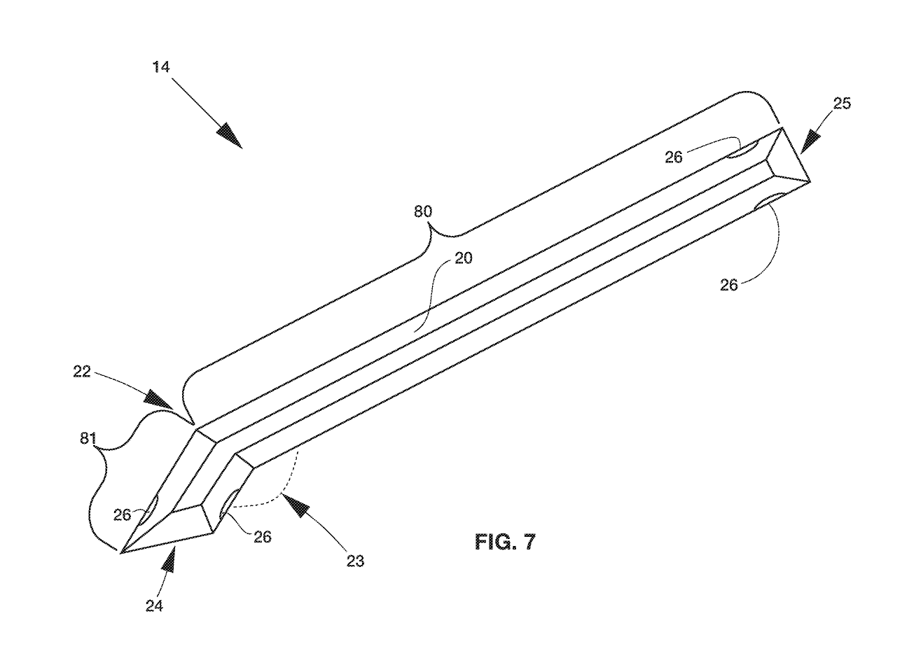

FIG. 7 depicts single bend cleaning device embodiment 14 with elongated member 20 having first terminal end 24 and second terminal end 25. Bend 22 is positioned near first terminal end 24 and forms angle 23. Bend 22 is preferably approximately 30°, with resulting longer segment 80 of elongated member being approximately 3.5″ and shorter segment 81 being approximately 0.5″.

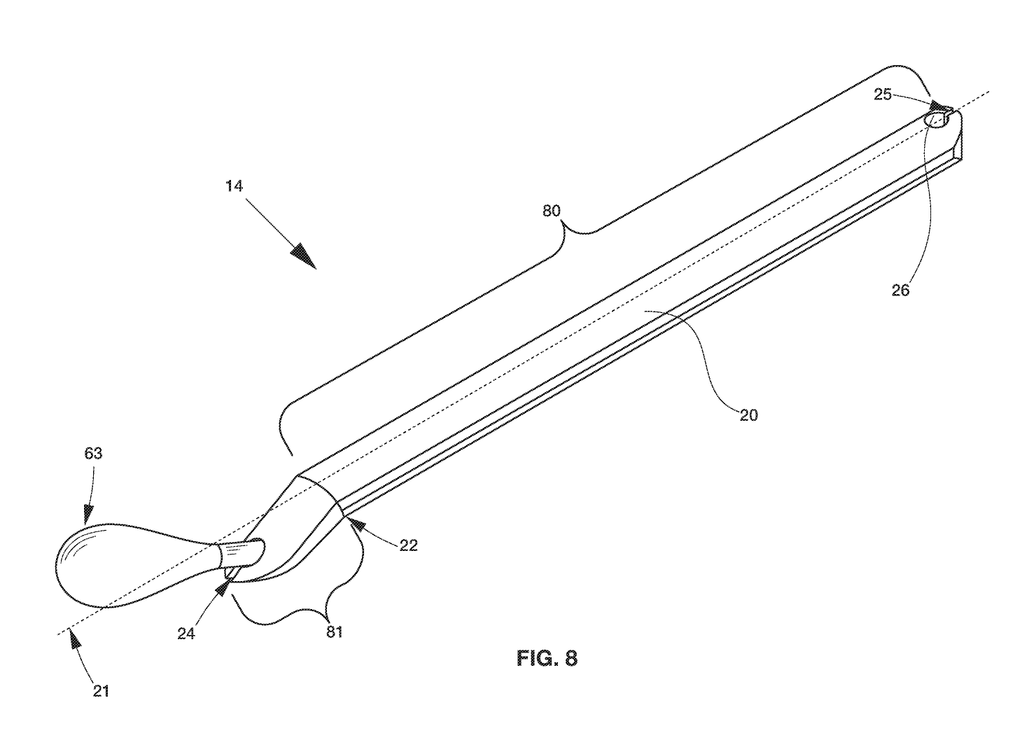

Referring to FIG. 8, cotton swab segment 63 held by aperture at first terminal end 24 protrudes approximately 165° relative to axis 21. If swab segment 63 were inserted upwardly through the same aperture at terminal end 24, the angle of protrusion relative to axis 21 would be approximately 15°. Aperture 26 at second terminal end 25 is oriented to secure swab segment at 90°. This embodiment is particularly well suited for use with semi-automatic rifles. The device is sized and configured to introduce cotton swab segments that have a rotating locking chamber such as M16/AR-15 style weapons.

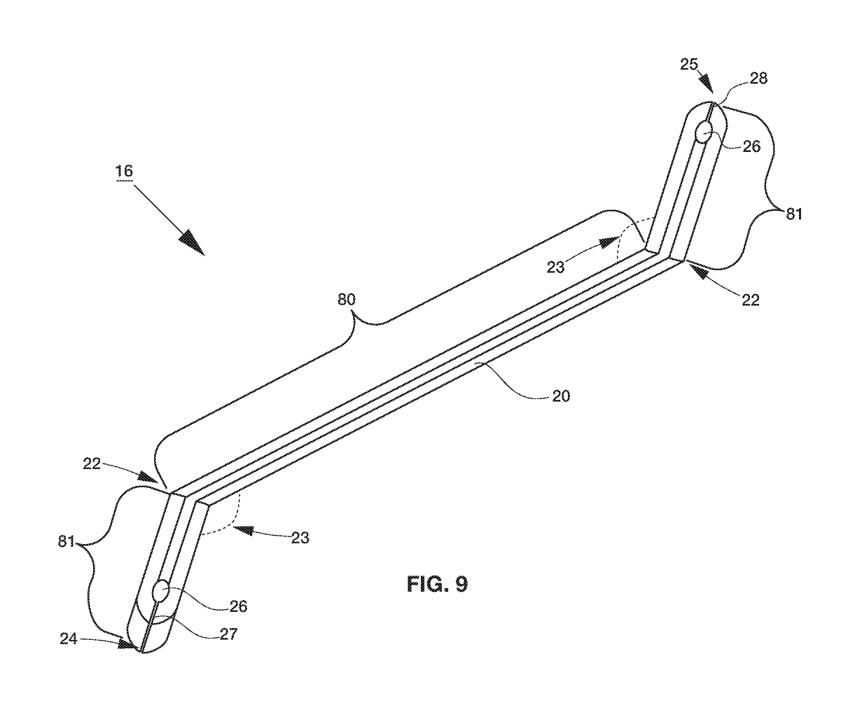

Double bend cleaning device embodiment 16 is shown in FIG. 9 with two bends 22 near each of first terminal end 24 and second terminal end 25, with both bends forming angles 23 of approximately 45°. Longer segment 80 of elongated member 20 is approximately 3.5″, with each shorter segment 81 being approximately 1.0″. Double bend cleaning device embodiment 16 is particularly well suited for cleaning deeper chambers such as those which are found on Remington 700 rifles. Cotton swab segments inserted into first terminal end are angled to clean the top front of the chamber and the bottom rear of the chamber, while cotton swab segments inserted into second terminal end are angled to clean the bottom front of the chamber and the top rear of the chamber.

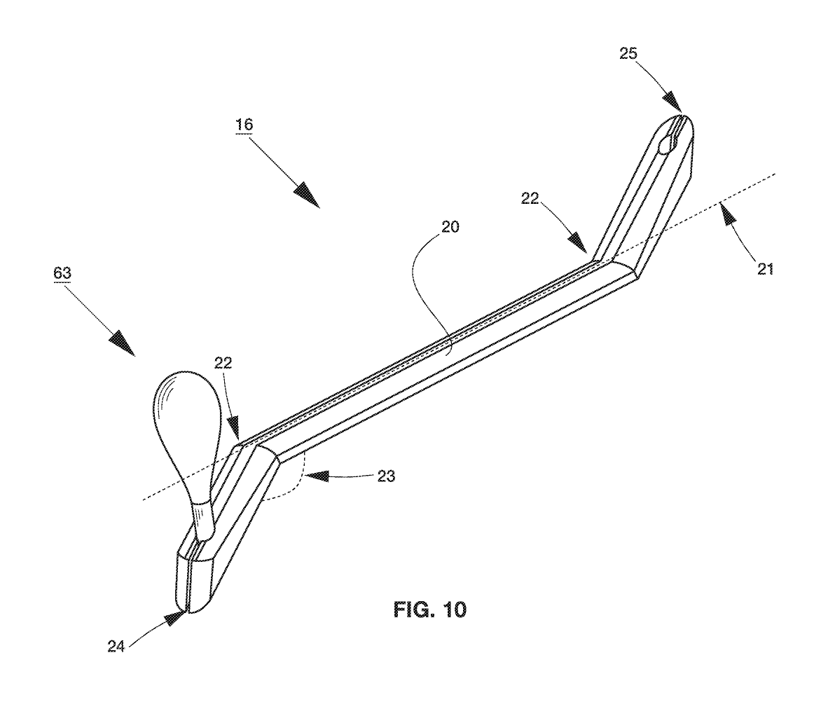

Referring to FIG. 10, cotton swab segment 63 protruding from aperture 26 at first terminal end 24 is ready to clean the bottom rear of lugs.

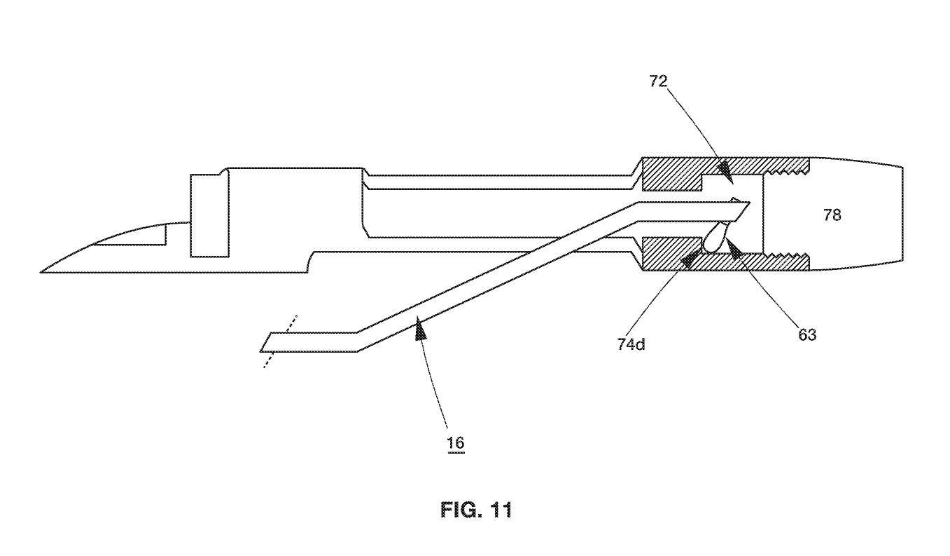

FIG. 11 depicts a Remington 700 weapon with partial sectional view of the locking lug area shown for illustration purposes. Device 16 is cleaning back locking lug surface 74d within chamber 72.

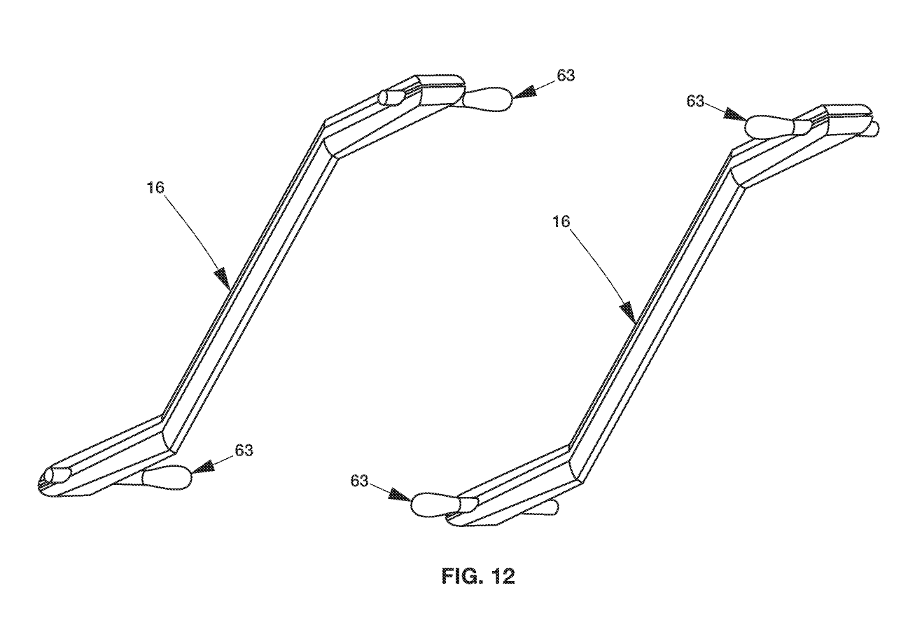

FIG. 12 depicts device 16 with swabs protruding in four different ways, corresponding with cleaning four major surfaces of R 700 and similar rifles. Device on the left depicts top swab positioned for cleaning bottom front surface of lug, and bottom swab is positioned for cleaning bottom rear surface of lug. Device on the right depicts top swab positioned for cleaning top rear surface of lug, and bottom swab is positioned for cleaning top front surface of lug.

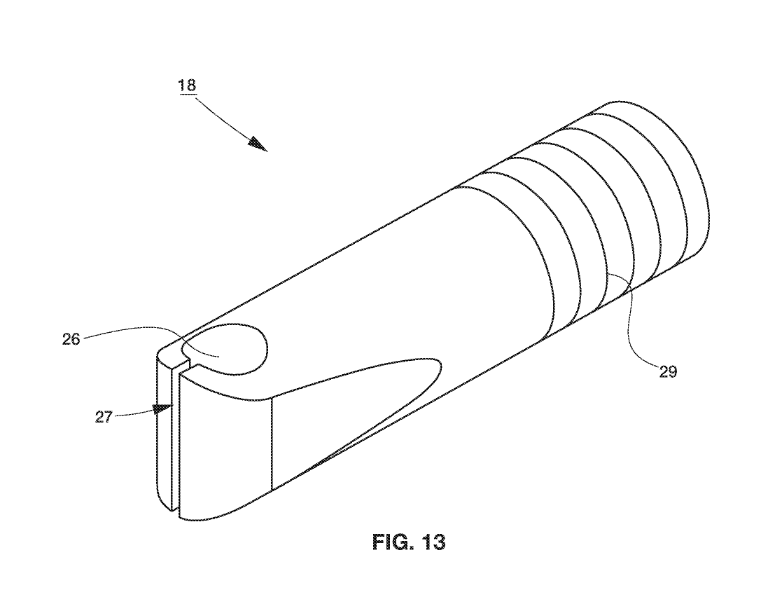

FIG. 13 depicts screw-on cleaning device embodiment 18 notably including attachment means 29. This embodiment is configured for use with existing commercially available weapons cleaning kits, for example from Otis Technology of Lyons Falls, N.Y.

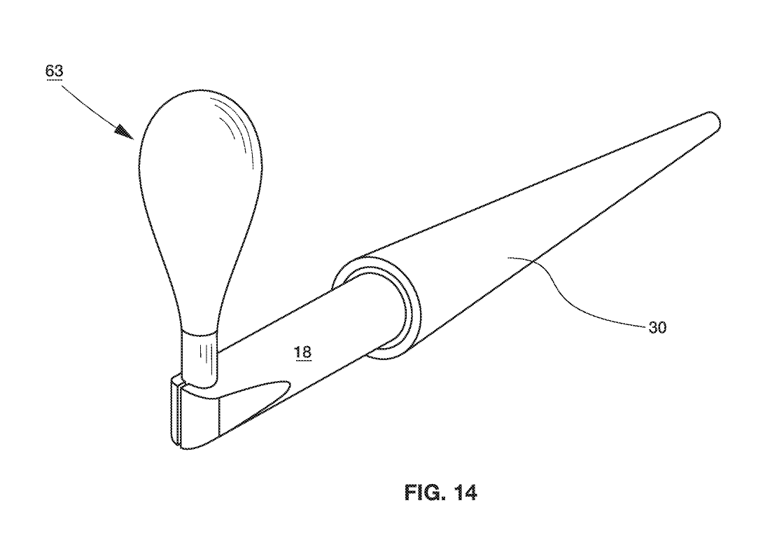

FIG. 14 depicts the screw-on cleaning device embodiment engaged with rod 30. It should be understood that this embodiment can employ internal threads for female—male engagement with rod 30. Also, attachment means 29 can alternatively use magnets, frictional fittings, or other known attachment mechanisms. Also, aperture 26 can be in a variety of angles, as set forth in the other embodiments, in order to position cotton swab segment 63 in a variety of angles. It should also be understood that screw-on cleaning device embodiment 18 can be used with other commercially available weapons cleaning kits.

In use, one cleaning their weapon would remove the front and rear takedown pins, break down the weapon to expose the upper receiver, and then remove the bolt carrier group from the upper receiver thereby exposing the opened upper receiver and chamber. A user would insert cotton swab stick 60 of cotton swab segment 63 within aperture 26 of cleaning device 10, and clean surfaces of upper receiver, chamber and locking lugs with cotton swab head 62 of cotton swab segment 63. Cotton swab segments should be replaced as they become soiled. Cotton swab segments may be formed by breaking cotton swab sticks to desired length, preferably ½″ to ¾″ from tip-to-tip. The specific cleaning device to employ depends on the model of the weapon. The specific aperture to employ depends on the surfaces of the weapon to be cleaned. The specific orientation of the aperture, upper or lower, that the cotton swab segments are inserted into depends also on the surfaces of the weapon to be cleaned.

Specifications of certain structures and components of the present invention have been established in the process of developing and perfecting prototypes and working models. These specifications are set forth for purposes of describing an embodiment, and setting forth the best mode, but should not be construed as teaching the only possible embodiment. Rather, modifications may be made without departing from the spirit and scope of the invention as set forth in the following claims. Examples of modifications include varying embodiment lengths and segment lengths and angles. It should be understood that all specifications, unless otherwise stated or contrary to common sense, are +/−10%, and that ranges of values set forth inherently include those values, as well as all increments between.

What is claimed is:

1. A rifle cleaning device including:
A) An elongated member with a longitudinal axis having a first terminal end and a second terminal end;
B) A first aperture defined by said first terminal end; and
C) A first hinge continuous with said first aperture, said first hinge for frictionally retaining a cylindrical object having a diameter of approximately 0.097-0.110 inches within said aperture.

2. The rifle cleaning device of claim 1 wherein said elongated member includes a first bend positioned closer to said first terminal end than to said second terminal end so as to form a first shorter segment angled from a longer segment at a first angle.

3. The rifle cleaning device of claim 2 wherein said first angle is selected from the group consisting of 30°, 45°, 90°, 135° and 165°.

4. The rifle cleaning device of claim 2 wherein said elongated member includes a second bend positioned closer to said second terminal end than to said first terminal end so as to form a second shorter segment angled from said longer segment at a second angle.

5. The rifle cleaning device of claim 4 wherein said second angle is selected from the group consisting of 30°, 45°, 90°, 135° and 165°.

6. The rifle cleaning device of claim 1 further including a second aperture defined by said second terminal end.

7. The rifle cleaning device of claim 6 further including a second hinge continuous with said second aperture, said second hinge for frictionally retaining a cylindrical object having a diameter of approximately 0.097-0.110 inches within said aperture.

8. A rifle cleaning system including:
A) An elongated device having a first terminal end with a first hinge, said first terminal end defining a first aperture; and
B) A first cotton swab segment engaged with said first aperture.

9. The rifle cleaning system of claim 8 wherein said first cotton swab is oriented at a non-linear angle relative to the longitudinal axis of said elongated device.

10. The rifle cleaning system of claim 9 wherein the angle formed between said first cotton swab and said longitudinal axis is selected from the group consisting of 15°, 45°, 90°, 135° and 165°.

11. The rifle cleaning system of claim 8 further comprising an attachment means for connecting said first terminal end.

12. The rifle cleaning system of claim 11 wherein said attachment means is a male to female screwing assembly.

13. The rifle cleaning system of claim 8 further comprising a second terminal end with a second hinge, said second terminal end defining a second aperture.

14. A method of cleaning the chamber of a bolt action rifle comprising the acts of:
A. Removing a bolt carrier group from an upper receiver of a bolt action rifle;
B. Inserting a cotton swab stick of a first cotton swab segment into an aperture of an elongated cleaning device having a longitudinal axis, said first cotton swab segment oriented at a non-linear angle relative to the longitudinal axis;
C. Rubbing the cotton swab head portion of the first cotton swab segment on locking lug surfaces of the chamber to remove debris.

15. The method of claim 14 wherein the act of rubbing the cotton swab head on surfaces of the locking lug includes the act of rubbing the cotton swab head on the back locking lug surfaces.

16. The method of claim 14 further including the act of breaking a cotton swab stick of a cotton swab to obtain a first cotton swab segment.

17. The method of claim 14 further including the acts of removing said first cotton swab segment from said aperture and inserting a second cotton swab segment.
